(19) United States
(12) Patent Application Publication
(10) Pub. No.: US 2023/0344873 A1
(43) Pub. Date: Oct. 26, 2023

(54) METHODS AND APPARATUS FOR SECURED INFORMATION TRANSFER

(71) Applicant: Intel Corporation, Santa Clara, CA (US)

(72) Inventors: Ned Smith, Beaverton, OR (US); Satish Jha, Portland, OR (US); S M Iftekharul Alam, Hillsboro, OR (US); Vesh Raj Sharma Banjade, Portland, OR (US); Kathiravetpillai Sivanesan, Portland, OR (US); Arvind Merwaday, Beaverton, OR (US); Liuyang Yang, Vancouver, WA (US); Rajesh Poornachandran, Portland, OR (US)

(21) Appl. No.: 18/345,865

(22) Filed: Jun. 30, 2023

(51) Int. Cl. H04L 9/40; G06Q 20/38

(52) U.S. Cl. CPC H04L 63/20; H04L 63/107; G06Q 20/389

(57) ABSTRACT

Methods and apparatus for secured information transfer are disclosed. An example apparatus includes programmable circuitry to execute instructions to determine characteristics of an asset associated with a first entity that utilizes a first type of decentralized security, assign the asset to a carrier for transport to a second entity that utilizes a second type of decentralized security, obtain attested information for the asset from the carrier, and transmit the attested information to the second entity via a first gateway, the first gateway to transmit the attested information for the asset to a second gateway of the second entity.

### BACKGROUND

In recent years, many types of computer systems have been integrated and connected for communication. Information sharing among such systems often relies upon mechanisms to facilitate trust of such information. Such trust may relate to verifying the source of the information, the validity of the information, the distribution path of the information, the manner in which the information is collected/generated, etc. For example, in a supply chain, it is often important for information to be shared throughout distribution of a product, software, etc. from one point to another. In autonomous vehicle systems, an automated vehicle may transmit information to and/or obtain information from many sources (e.g., other vehicles, traffic control systems, etc.) to be used to determine how a vehicle should operate.

### BRIEF DESCRIPTION OF THE DRAWINGS

FIG. 1 is a block diagram of an example environment in which an example asset management server(s) operates to manage the transfer of an asset from a source to a destination.

FIG. 2 is a block diagram of an example implementation of the asset management server of FIG. 1.

FIGS. 3-6 are flowcharts representative of example machine readable instructions and/or example operations that may be executed, instantiated, and/or performed by example programmable circuitry to implement the asset management server of FIG. 2.

FIG. 7 is a block diagram of an example environment in which an example vehicle communicates with other sources of information while travelling from a source location to a destination.

FIG. 8 is a block diagram of an example implementation of the vehicle to anything (V2X) node manager of FIG. 7.

FIG. 9 is a flowchart representative of example machine readable instructions and/or example operations that may be executed, instantiated, and/or performed by example programmable circuitry to implement the V2X node manager of FIG. 8.

FIG. 10 is a block diagram of an example environment in which an example attestation and self-test processor circuitry analyzes self-test and attestation information of components of a vehicle to determine an automation level for the vehicle.

FIG. 11 is a block diagram illustrating evidence and self-test collection of a sensor of the vehicle of FIG. 10.

FIG. 12 is a block diagram of an example implementation of the attestation and self processor circuitry of FIG. 10.

FIGS. 13-14 are flowcharts representative of example machine readable instructions and/or example operations that may be executed, instantiated, and/or performed by example programmable circuitry to implement the attestation and self processor of FIG. 12.

FIG. 15 is a block diagram of an example processing platform including programmable circuitry structured to execute, instantiate, and/or perform the example machine readable instructions and/or perform the example operations of FIGS. 3-6, 9, 13 to implement the asset management server 106 of FIG. 2, the V2X node manager 800 of FIG. 8, and/or the attestation and self-test processor 1006 of FIG. 11.

FIG. 16 is a block diagram of an example implementation of the programmable circuitry of FIG. 15.

FIG. 17 is a block diagram of another example implementation of the programmable circuitry of FIG. 15.

FIG. 18 is a block diagram of an example software/firmware/instructions distribution platform (e.g., one or more servers) to distribute software, instructions, and/or firmware (e.g., corresponding to the example machine readable instructions of FIGS. 3-6, 9, 13, 14) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Attestation refers to the concept of a trusted entity, device, person, process, etc. verifying the authenticity of data, an object, a document, etc. For example, a first party may trust an attestor and, therefore, trust the validity of data, an object, a document, etc. that has been attested by the attestor. To facilitate trust, the attestation may be combined with mechanisms to ensure that the attestation is not tampered with, impersonated, or otherwise falsely conveyed. For example, methods and apparatus disclosed herein utilize multi-layered approaches such as Root of Trust (RoT) mechanisms, secured storage (e.g., secure enclave storage), digital certificates, key based encryption, distributed ledgers, cryptography, etc.

Supply chains are often dominated by a central entity, such as a manufacturer of a finished good, that builds a network of suppliers who agree to use supply chain automation technology that is specific to the central entity. This approach results in siloed supplier networks that are slow to innovate, which diminishes value in the overall supply chain. Decentralization technologies may avoid “lock in” isolation with a central supply chain. For example, distributed ledger technology (DLT) relies on a collection of entities that store ledger information independently on separate, but connected, devices, which supports independent verification and trust of the data. However, decentralization may create a different form of isolation where the supplier community is locked in to a particular DLT. Interaction with “outside” DLT communities may pose risks where technologies are used that do not support properties such as Atomicity, Consistency, Isolation, Durability (ACID). Although supply chains may consist of many seemingly independent suppliers, suppliers may form a coalition with a central entity agreeing to use a common set of tools, business processes and value chain conventions. Suppliers attempting to build a multi-stakeholder value chain are met with undesirable trade-offs where the cost of working with multiple central suppliers means having to support multiple incompatible supply chain automation tooling and practices.

Methods and apparatus disclosed herein utilize an asset management server of a first entity (e.g., a supplier, supplier network, etc.) that communicates via a gateway (e.g., a secure asset transfer (SAT) gateway) with a second entity via a gateway of the second entity. In some examples, the asset management server and gateway support standards that preserve ACID properties across the gateway interface. Consistency implies that an asset transfer protocol leaves both networks in a consistent state (that at any moment the asset must be located in one network only). Atomicity means that either the transfer commits entirely (completes) or entirely fails, where failure is taken to mean there is no change to the state of the asset in the origin network. Isolation means that while a transfer is occurring to a digital asset from an origin network, no other state changes can occur to the asset (e.g., the gateway prevents state changes during transfer). The property of durability means that once the transfer has been committed by both gateways, the commitment must hold regardless of subsequent unavailability (e.g., a crash) of the gateways implementing the transfer protocol. In some examples, different entities can link the unique and innovative technologies together via such an approach. Some methods and apparatus disclosed herein facilitate the coordination of transfer of an asset (e.g., a physical asset such as a shipment or an electronic asset) with transfer of information about the asset (e.g., a bill of lading (BOL). Some example methods and apparatus facilitate trust in the communication of such information allowing reliance on the information for trust in the history of the asset (e.g., shipping history such as locations, shipping conditions, etc.).

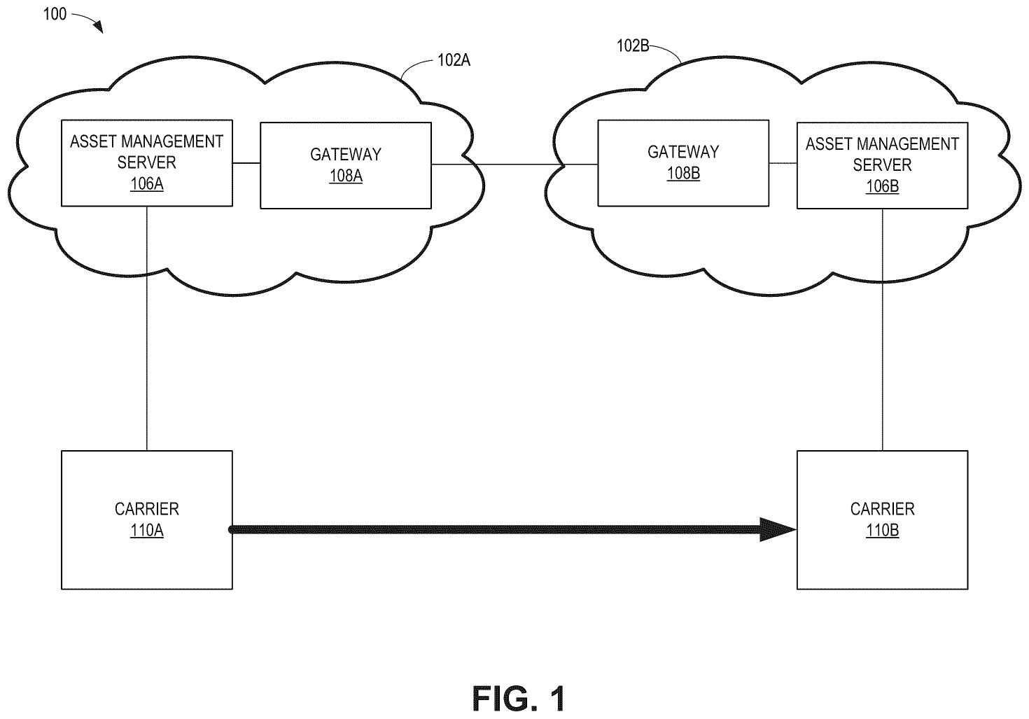

FIG. 1 is a block diagram of an example environment 100 in which an example asset management server 106A operates to manage the transfer of an asset from a source to a destination. The example environment includes a first entity 102A associated with a first carrier 110A and a second entity 102B associated with a second carrier 110B.

The example first entity 102A and the example second entity 102B are supplier networks. Alternatively, the first entity 102A and the second entity 102B may be individual suppliers, financial entities/networks, digital and/or crypto currency suppliers/networks, and/or any other type of transactional entities. The example first entity 102A includes an example asset management server 106A and an example gateway 108A. The example second entity 102B includes an example gateway 108B and an example asset management server 106B. In the following description, the asset management server 106A and the gateway 108A are described by way of example. Of course, any of the characteristics and/or operation of the asset management server 106A and the gateway 108A described herein may be applicable to the asset management server 106B and the gateway 108B. While the example environment includes two entities 102A,102B, any number of entities may be present in a supply chain.

According to the illustrated example, the first entity 102A and the second entity 102B utilize different security structures such as different decentralized security types. A decentralized security is a security architecture that manages information security without a dedicated central authority. For example, the decentralized security may utilize blockchain, distributed ledger technology, root of trust, or any other type of decentralized security architecture. According to the illustrated example, the first entity 102A may utilize a first decentralized security type or architecture and the second entity 102B may utilize a second decentralized security type or architecture. For example, the first entity 102A may utilize a first distributed ledger technology network and the second entity 102B may utilize a second distributed ledger technology network. Accordingly, the example gateway 108A may operate within the first distributed ledger technology network and the example gateway 108B may operate within the second distributed ledger technology network. Thus, while the asset management server 106A cannot communicate the asset information from the first distributed ledger technology network direct to the second distributed ledger technology network, the gateway 108A facilitates communication of the asset information to the gateway 108B.

The example asset management server 106A is processor circuitry to manage the transmission and receipt of information regarding a transfer (e.g., shipment). The example information is a bill of lading that describes the contents of the asset transmission by the carrier 110A. Alternatively, the asset management server 106A of the first entity 102A communicates with the second entity via the example gateway 108A. According to the illustrated example, the asset management server 106A obtains attested attributes of the asset to be transferred from the carrier 110A to generate the bill of lading. The asset management server 106A additionally receives asset information from other entities (e.g., from the gateway 108A) (e.g., in conjunction with a transfer of an asset (e.g., a physical asset or an electronic asset).

The example gateway 108A is a secure asset transfer protocol (SAT) gateway to manage communication between the first entity 102A and the second entity 102B. According to the illustrated example, the gateway 108A facilitates inter-communication between the entities 102A,102B even when the entities 102A,102B operate according to different technologies (e.g., different DLT technologies). The example gateway 108A utilizes a SAT protocol that has ACID (Availability, Consistency, Integrity, Durability) properties such that information to be transferred (e.g., a BoL) will transition from the first entity 102A to the second entity 102B without error or, if an error occurs, will rollback the information to the first entity 102A.

The example carrier 110A and the example carrier 110B are shippers for carrying physical goods. According to the illustrated example, the carrier 110A is associated with the first entity 102A and the carrier 110B is associated with the second entity 102B. Alternatively, the carrier 110A and the carrier 110B may be other entities involved in the transportation, distribution, and/or transmission of assets such as physical assets and electronic assets.

In operation of environment 100, the asset management server 106A, while in possession of an asset, describes the asset in sufficient detail that a Said to Contain (STC) description can be used in a BoL. If the asset is electronic, an attestation of the device is used to obtain STC attributes that are included in the BoL. The asset management server 106A assigns the asset to the carrier 110A for transport to the second entity 102B. The carrier 110A returns a BoL (with attested attributes if an electronic asset), that acknowledges receipt of the asset (e.g., while contractually retaining asset ownership with the first entity 102A). The asset management server 106A delivers the BoL to the gateway 108A, which, in response, contacts the gateway 108B of the second entity 102B. The gateway 108A transfers the BoL to second entity 102B. For example, the gateways 108A,108B may utilize a SATP protocol that has ACID (Availability, Consistency, Integrity, Durability) properties such that the BoL transfer will reliably transition from the first entity 102A to the second entity 102B or it will reliably rollback to first entity 102A if not accepted. The gateway 108B of the second entity 102B forwards the BoL to asset management server 106B of the second entity 102B for completion of the asset transfer processing.

Meanwhile, the carrier 110A completes the physical transfer of the asset to carrier 110B of the second entity 102B (or directly to the second entity 102B). For example, a warehouse connected to the second entity 102B may catalogs receipt of physical assets delivered by the carrier 110A. Alternatively, if the asset is electronic, an attestation of the device is obtained and compared with the attestation results found in the BoL. The asset management server 106B delivers the BoL for the asset to the carrier 110A,110B thereby clearing the carrier 110A,110B of any liability for the asset. The carrier 110A,110B delivers the asset to asset management server 106B (or a warehouse/loading dock under the control of asset management server 106B/the second entity 102B).

In some cases, there may be a period between the receipt of the asset at a loading dock/warehouse and the time the device can be deployed for attestation. In such a case, the BoL may be delivered and the asset may be delivered to the asset management server 106B before attestation, but asset management server 106B may reject the BoL after it has accepted transfer of the asset. Accordingly, the asset may then be transferred back to first entity 102A by the second entity 102B using a similar protocol as described here.

The example asset management server 106A protects the BoL from modification by cryptographically protecting the BoL during the exchange. Thus, the BoL may be considered a digital asset that can be electronically transferred. Alternatively, other approaches for protecting the BoL may be utilized. For example, the BoL may be stored in a DLT, the BoL may be registered with a financial institution (e.g., a bank, an international bank, a payment processing infrastructure, etc.). In some implementations, the BoL transfer may be integrated with a financial transaction that offsets the value of goods transferred and/or compensates the overhead associated with the processing of the good and/or BoL. For example, the financial transaction may be a decentralized digital currency transaction such as a cryptocurrency currency transaction, a stablecoin transaction, a blockchain based financial transaction, etc.

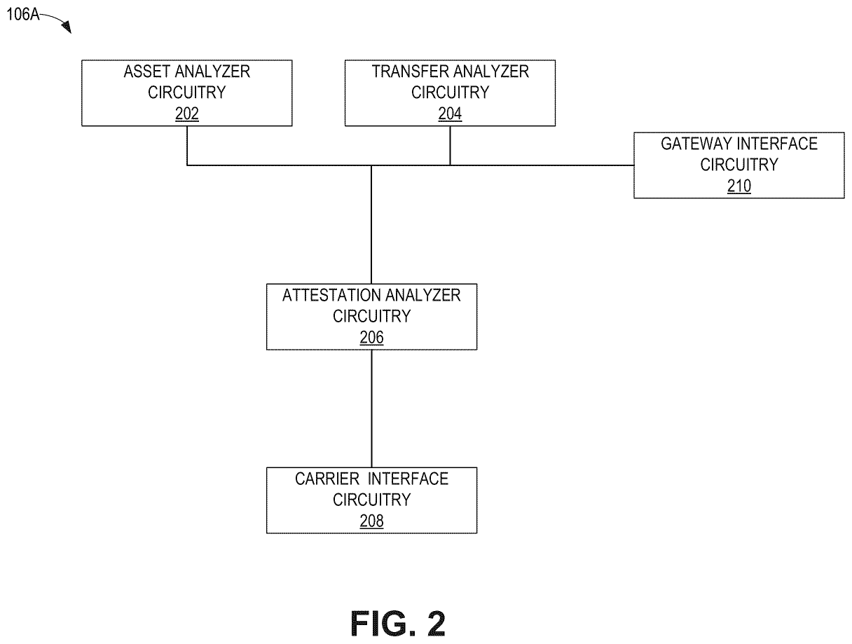

FIG. 2 is a block diagram of an example implementation of the asset management server 106A of FIG. 1 to do manage the transfer of an asset between entities (e.g., suppliers, supplier networks, distribution networks, etc.). The asset management server 106A of FIG. 2 may be instantiated (e.g., creating an instance of, bring into being for any length of time, materialize, implement, etc.) by programmable circuitry such as a Central Processor Unit (CPU) executing first instructions. Additionally or alternatively, the asset management server 106A of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example asset management server 106A of FIG. 2 includes an example asset analyzer circuitry 202, an example transfer analyzer circuitry 204, an example attestation analyzer circuitry 206, an example carrier interface circuitry 208, and an example gateway interface circuitry 210.

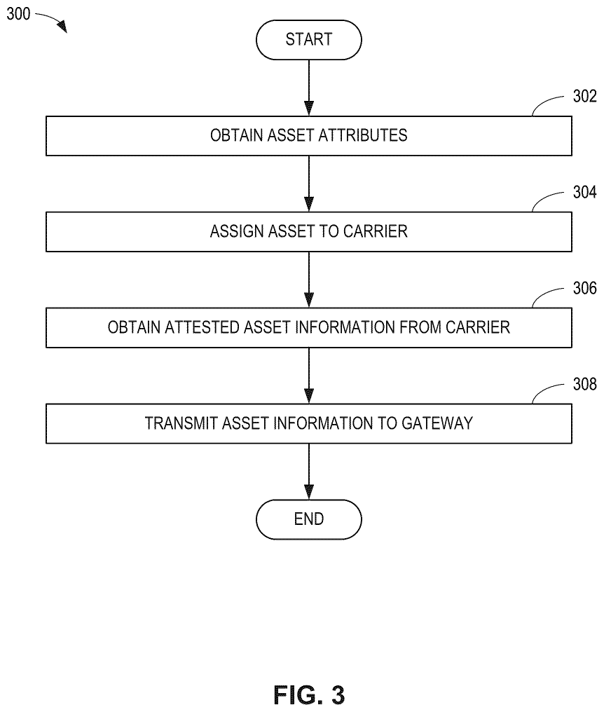

The example asset analyzer circuitry 202 describes and/or attests an asset to be transferred. For example, the asset analyzer circuitry 202 may determine a description of the asset (e.g., from documentation associated with the asset, from user input of information about the asset) and/or may perform an attestation of an electronic asset (e.g., by performing an analysis that extracts characteristics of the asset). The asset analyzer circuitry 202 may cryptographically protect the asset information from modification. In some examples, the asset analyzer circuitry 202 is instantiated by programmable circuitry executing asset analyzer instructions and/or configured to perform operations such as those represented by the flowchart(s) of FIGS. 3-6

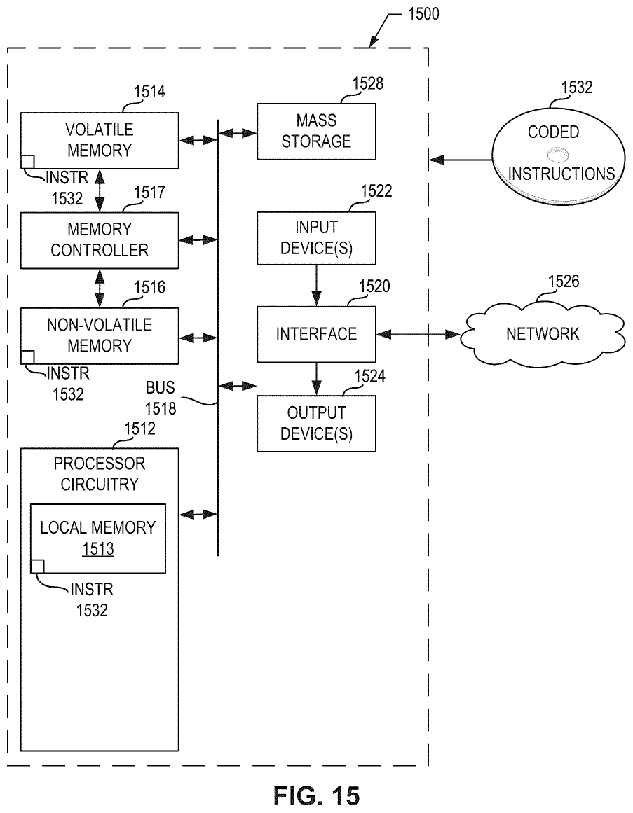

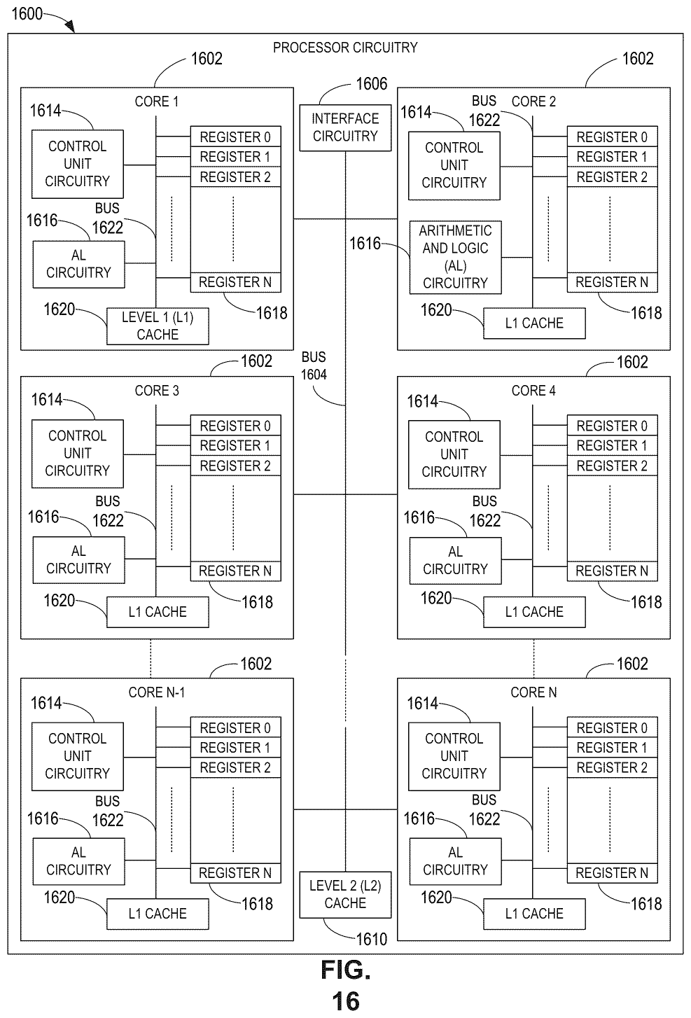

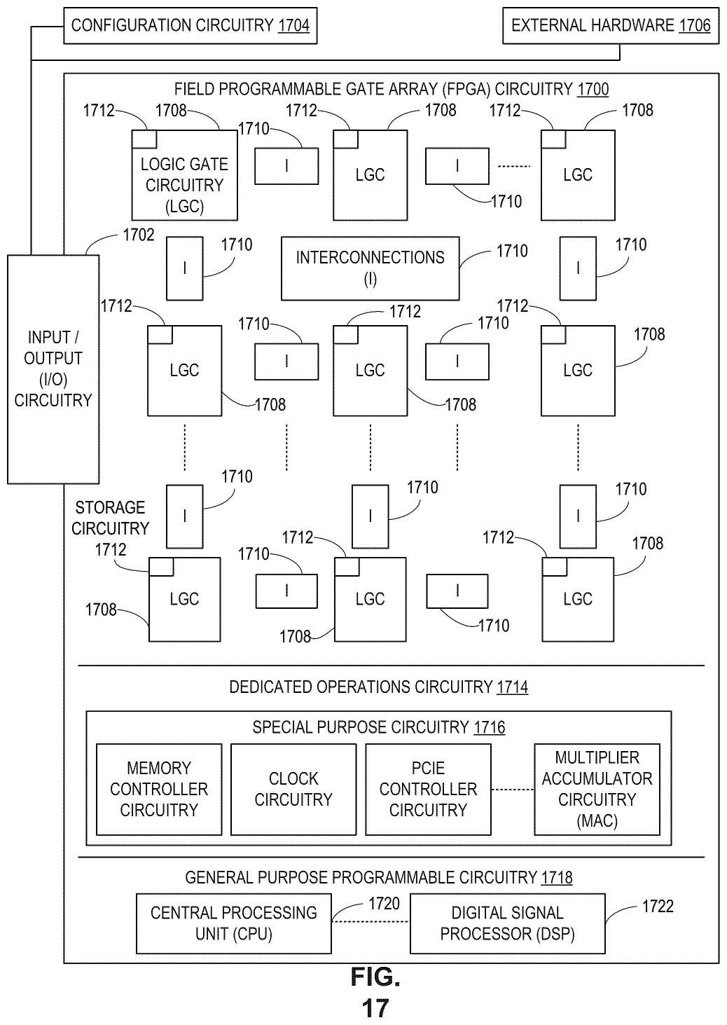

In some examples, the asset management server 106A includes means for analyzing an asset. For example, the means for analyzing an asset may be implemented by asset management server circuitry 106A. In some examples, the asset management server circuitry 106A may be instantiated by programmable circuitry such as the example programmable circuitry 1512 of FIG. 15. For instance, the asset management server circuitry 106A may be instantiated by the example microprocessor 1600 of FIG. 16 executing machine executable instructions such as those implemented by at least blocks 302, 304 of FIG. 3. In some examples, asset management server circuitry 106A may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the asset management server circuitry 106A may be instantiated by any other combination of hardware, software, and/or firmware. For example, the asset management server circuitry 106A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example transfer analyzer circuitry 204 determines if an asset that is received by the asset management server 106A is to be accepted. For example, the transfer analyzer circuitry 204 may analyze information received from the attestation analyzer circuitry 206 to determine if the validity of the asset can be trusted, if the asset has been transferred according to transfer rules (e.g., geographic policies, geographic policy restrictions, geographic limits, shipping conditions, etc.). In some examples, the transfer analyzer circuitry 204 is instantiated by programmable circuitry executing transfer analyzer instructions and/or configured to perform operations such as those represented by the flowchart(s) of FIGS. 3-6

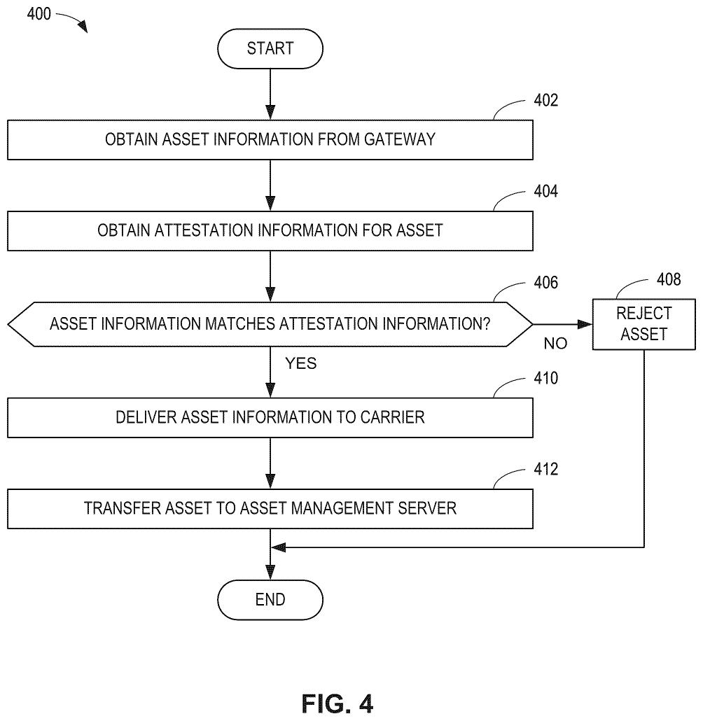

In some examples, the asset management server 106A includes means for analyzing a transfer. For example, the means for analyzing a transfer may be implemented by transfer analyzer circuitry 204. In some examples, the transfer analyzer circuitry 204 may be instantiated by programmable circuitry such as the example programmable circuitry 1512 of FIG. 15. For instance, the transfer analyzer circuitry 204 may be instantiated by the example microprocessor 1600 of FIG. 16 executing machine executable instructions such as those implemented by at least blocks 406-410 of FIG. 4. In some examples, transfer analyzer circuitry 204 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the transfer analyzer circuitry 204 may be instantiated by any other combination of hardware, software, and/or firmware. For example, the transfer analyzer circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example attestation analyzer circuitry 206 analyzes attestation information (e.g., an attestation BoL) received from the carrier 110A. For example, the attestation analyzer circuitry 206 obtains an attested BoL from the carrier 110A. In some examples, the attestation analyzer circuitry 206 is instantiated by programmable circuitry executing attestation analyzer instructions and/or configured to perform operations such as those represented by the flowchart(s) of FIGS. 3-6

In some examples, the asset management server 106A includes means for analyzing attestation information. For example, the means for analyzing attestation information may be implemented by attestation analyzer circuitry 206. In some examples, the attestation analyzer circuitry 206 may be instantiated by programmable circuitry such as the example programmable circuitry 1512 of FIG. 15. For instance, the attestation analyzer circuitry 206 may be instantiated by the example microprocessor 1600 of FIG. 16 executing machine executable instructions such as those implemented by at least blocks 306 of FIG. 3. In some examples, attestation analyzer circuitry 206 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the attestation analyzer circuitry 206 may be instantiated by any other combination of hardware, software, and/or firmware. For example, the attestation analyzer circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example carrier interface circuitry 208 connects the example asset management server 106A with a carrier (e.g., the carrier 110A of FIG. 1). According to the illustrated example, the carrier interface circuitry 208 is a network interface circuitry. Alternatively, any other type of interface may be utilized such as a webpage interface, a user input interface, an interface to a storage medium (e.g., a removable media interface). In some examples, the carrier interface circuitry 208 is instantiated by programmable circuitry executing carrier interface instructions and/or configured to perform operations such as those represented by the flowchart(s) of FIGS. 3-6

In some examples, the asset management server 106A includes means interfacing with a carrier. For example, the means for interfacing with a carrier may be implemented by carrier interface circuitry 208. In some examples, the carrier interface circuitry 208 may be instantiated by programmable circuitry such as the example programmable circuitry 1512 of FIG. 15. For instance, the carrier interface circuitry 208 may be instantiated by the example microprocessor 1600 of FIG. 16 executing machine executable instructions such as those implemented by at least blocks 402 of FIG. 4. In some examples, carrier interface circuitry 208 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the carrier interface circuitry 208 may be instantiated by any other combination of hardware, software, and/or firmware. For example, the carrier interface circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example gateway interface circuitry 210 communicatively couples the asset management server 106A to a gateway (e.g., the gateway 108A of the first entity 102A) to facilitate communication with another entity (e.g., an entity outside of the first entity 102A such as the second entity 102B). According to the illustrated example, the gateway interface circuitry 210 is a network interface that couples the asset management server 106A to the gateway 108A via network communication protocols. Alternatively, the gateway interface circuitry 210 may be any other type of interface (e.g., an application programming interface (API), a memory interface, etc.). In some examples, the gateway interface circuitry 210 is instantiated by programmable circuitry executing gateway interface instructions and/or configured to perform operations such as those represented by the flowchart(s) of FIGS. 3-6

In some examples, the asset management server 106A includes means interfacing with a gateway. For example, the means for interfacing may be implemented by gateway interface circuitry 210. In some examples, the gateway interface circuitry 210 may be instantiated by programmable circuitry such as the example programmable circuitry 1512 of FIG. 15. For instance, the gateway interface circuitry 210 may be instantiated by the example microprocessor 1600 of FIG. 16 executing machine executable instructions such as those implemented by at least blocks 308 of FIG. 3. In some examples, gateway interface circuitry 210 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the gateway interface circuitry 210 may be instantiated by any other combination of hardware, software, and/or firmware. For example, the gateway interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the asset management server 106A of FIG. 1 is illustrated in FIG. 2, one or more of the elements, processes, and/or devices illustrated in FIG. 2 may be combined, divided, re-arranged, omitted, eliminated, and/or implemented in any other way. Further, the example asset analyzer circuitry 202, the example transfer analyzer circuitry 204, the example attestation analyzer circuitry 206, the example carrier interface circuitry 208, the example gateway interface circuitry 210, and/or, more generally, the example asset management server 106A of FIG. 2, may be implemented by hardware alone or by hardware in combination with software and/or firmware. Thus, for example, any of the example asset analyzer circuitry 202, the example transfer analyzer circuitry 204, the example attestation analyzer circuitry 206, the example carrier interface circuitry 208, the example gateway interface circuitry 210, and/or, more generally, the example asset management server 106A, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example asset management server 106A of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the asset management server 106A of FIG. 2 and/or representative of example operations which may be performed by programmable circuitry to implement and/or instantiate the asset management server 106A of FIG. 2, are shown in FIGS. 3-6. The machine readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by the example programmable circuitry (e.g., an FPGA) discussed below in connection with FIGS. 16 and/or 17. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example asset management server 106A may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to manage transfer of an asset information such as a BoL associated with a shipment. The example machine-readable instructions and/or the example operations 300 of FIG. 3 begin at block 302, at which the asset analyzer circuitry 202 of the asset management server 106A obtains asset attributes for an asset to the transferred. For example, the while asset management server 106A is in physical possession of the asset, the asset analyzer circuitry 202 may determine characteristics, descriptive information, attestation information etc. about the asset to develop a Said to Contain (STC) description for a BoL. The descriptive information may be collected from and/or stored in a secure (e.g., access-restricted) memory such as a secure enclave that is protected by processor circuitry (e.g., an enclave of the INTEL® SOFTWARE GUARD EXTENSIONS (SGX)).

The example transfer analyzer circuitry 204 determines a carrier (e.g., the carrier 110A) and assigns the asset to the carrier for transfer to another entity (e.g., the second entity 102A) (block 304). In response to and/or after the asset is assigned to the carrier, the example attestation analyzer circuitry 206 obtains attested asset information from the carrier via the carrier interface circuitry 208 (block 306). For example, the carrier may return a BoL (e.g., with attested attributes), that acknowledges receipt of the asset while contractually retaining asset ownership with the first entity 102A. The example transfer analyzer circuitry 204 transmits the asset information to a gateway (e.g., the gateway 108A) via the gateway interface circuitry 210 to facilitate transmission of the asset information to another entity (e.g., the second entity 102B) (block 308). For example, the transfer analyzer circuitry 204 may deliver the BoL to the gateway 108B, which, in response, contacts the gateway 108B of the second entity 102B to transfer the BoL to the second entity 102B. The gateway 108A and the gateway 108B may exchange credentials and/or other security information, cryptographic information, certificate information, etc. to validate the identity of the entities 102A,102B and provide a confirmation, a receipt, a manifest, etc. to provide proof of the transfer of the BoL or other asset information from the first entity 102A to the second entity 102B. For example, the gateway 102A may employ an INTEL® WIRELESS CREDENTIAL EXCHANGE (WCE) to support a contactless (e.g., radio frequency identification (RFID), secure, tamper resistant Trusted Environment that can be scanned wirelessly at gateway transaction points to register the transfer of the asset information from a decentralized security of the first entity 102A to a decentralized security of the second entity 102B (e.g., to register the removal of the asset information from a first distributed ledger and register the addition of the asset to the second distributed ledger).

FIG. 4 is a flowchart representative of example machine readable instructions and/or example operations 400 that may be executed, instantiated, and/or performed by programmable circuitry to receive asset information (e.g., a BoL) from another entity via a gateway. To facilitate description, the description of FIG. 4 is described in connection with the asset management server 106B of the second entity 102B receiving the information from the first entity 102A (e.g., by way of the transmission process described in conjunction with FIG. 3). Of course, the process of FIG. 4 may, alternatively, implement the asset management server 106A.

The example machine-readable instructions and/or the example operations 400 of FIG. 4 begin at block 402, at which the transfer analyzer circuitry 204 obtains asset information from the gateway 108B via the gateway interface circuitry 210. For example, the asset may be transferred to a warehouse of the second entity 102B at which point information about the received asset may be generated, collected, etc. The attestation analyzer circuitry 206 also obtains attestation information from the carrier (e.g., the carrier 110B) for the asset via the carrier interface circuitry 208 (block 404). The example attestation analyzer 206 determines if the asset information matches the attestation information (block 406). If the asset information does not match the attestation information (or the attestation information is not available for review), the attestation analyzer circuitry 206 rejects the asset (block 408). For example, the attestation analyzer circuitry 206 may refuse to accept the asset, may reject the BoL, and/or may otherwise cause the asset to be transferred back to the first entity.

If the attestation information is validated (block 406), the attestation analyzer circuitry 206 delivers asset information (e.g., the BoL to the carrier (block 410). The transfer analyzer circuitry 204 then accepts the transfer of the asset to the asset management server 206B (block 412).

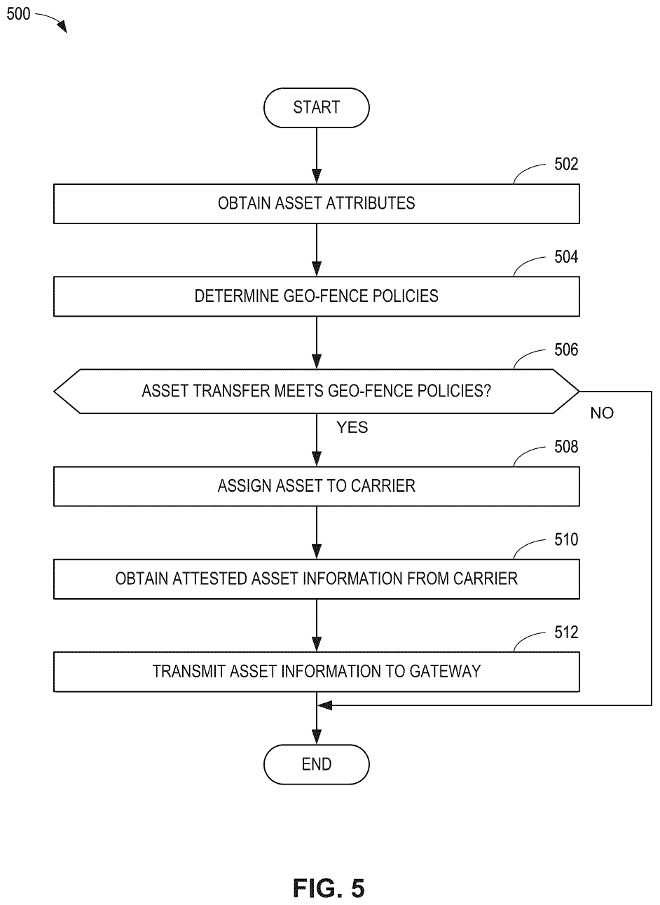

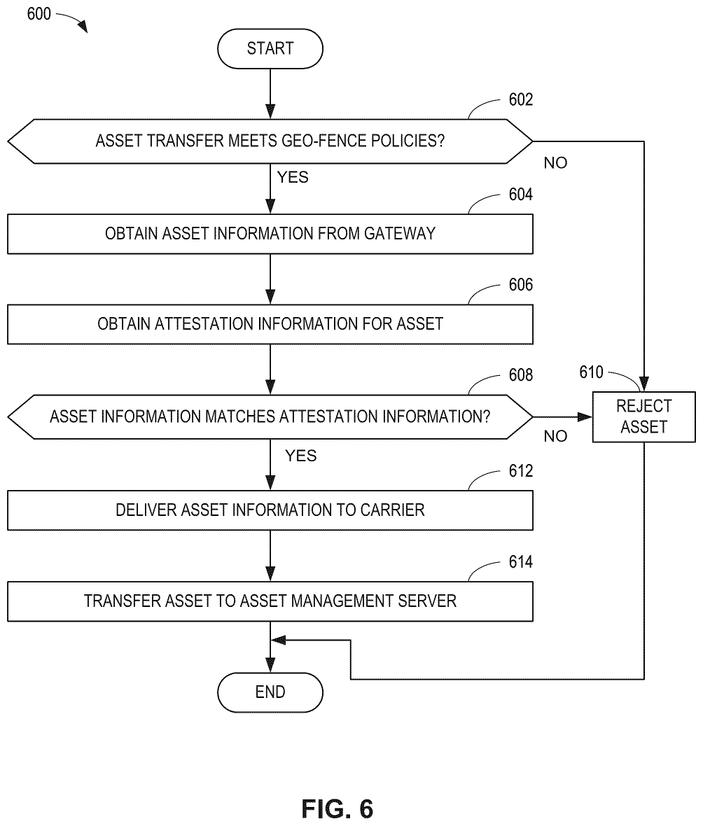

FIGS. 5-6 illustrate a process similar to the flowcharts of FIGS. 3-4, but with the added functionality of analyzing a geographic fence (Geo Fence) policy. Geo-political policies may regulate which goods can flow between various geo-fenced zones. The gateways 108A,108B synchronize an atomic transfer of the asset once one geo-fence zone is in physical possession of the good. While an example geo fence policy is described, any other type of policy may be managed (e.g., a shipping conditions policy, a timing policy, etc.).

FIG. 5 is a flowchart representative of example machine readable instructions and/or example operations 500 that may be executed, instantiated, and/or performed by programmable circuitry to transfer asset information and manage geo-fence policies. To facilitate description, the description of FIG. 5 is described in connection with the asset management server 106A of the first entity 102A. Of course, the process of FIG. 5 may, alternatively, implement the asset management server 106B.

The example machine-readable instructions and/or the example operations 500 of FIG. 5 begin at block 502 at which the asset analyzer circuitry 202 of the asset management server 106A obtains asset attributes for an asset to the transferred. For example, the while asset management server 106A is in physical possession of the asset, the asset analyzer circuitry 202 may determine characteristics, descriptive information, attestation information etc. about the asset to develop a Said to Contain (STC) description for a BoL. The descriptive information may be collected from and/or stored in a secure (e.g., access-restricted) memory such as a secure enclave that is protected by processor circuitry (e.g., an enclave of the INTEL® SOFTWARE GUARD EXTENSIONS (SGX)).

The example transfer analyzer circuitry 204 determines geo-fence policies associated with the transfer (block 504). For example, a transfer of an asset may have restrictions that dictate a shipping route, that restrict the asset from passing through a particular geographic area/region, etc. The example transfer analyzer circuitry 204 obtains the geo-fence policy information from the gateway 108A via the gateway interface circuitry 210. For example, the gateway 108A may negotiate geo-fenced policies to determine which constraints to apply to the asset to be transferred. The respective import/export rules for each geo-political domain associated with a shipment may be consulted in order to determine which rules apply to the particular shipment (e.g., which rules apply to the type of asset to be transferred, which rules apply to the source and/or destination for the asset, etc.). For example, if the asset contains controlled cryptography functions, then the details of the controlled asset may be applied. An attestation of the asset may reveal insight about the controlled asset that further identifies which geo-fence/geo-political rules should be applied.

The example transfer analyzer circuitry 204 then determines if the asset transfer meets geo-fence policies (block 506). For example, transfer analyzer circuitry 204 may determine that the next shipping destination, an intermediate destination, and/or the final destination are restricted due to the geo-fence policies, may determine that a next destination, intermediate destination, and/or final destination require payment of a tax, etc. If the transfer analyzer circuitry 204 determines that the geo-fence policies cannot be met, the process of FIG. 5 ends and the shipment is not transferred to a carrier. For example, a notification, message, alert, etc. may be transmitted to alert a user, administrator, carrier, etc. that the transfer cannot continue as designed.

If the asset transfer is determined to meet geo-fence policies (block 506), the example transfer analyzer circuitry 204 determines a carrier (e.g., the carrier 110A) and assigns the asset to the carrier for transfer to another entity (e.g., the second entity 102A) (block 508). In response to and/or after the asset is assigned to the carrier, the example attestation analyzer circuitry 206 obtains attested asset information from the carrier via the carrier interface circuitry 208 (block 510). For example, the carrier may return a BoL (e.g., with attested attributes), that acknowledges receipt of the asset while contractually retaining asset ownership with the first entity 102A. The example transfer analyzer circuitry 204 transmits the asset information to a gateway (e.g., the gateway 108A) via the gateway interface circuitry 210 to facilitate transmission of the asset information to another entity (e.g., the second entity 102B) (block 512). For example, the transfer analyzer circuitry 204 may deliver the BoL to the gateway, which, in response, contacts the gateway 108B of the second entity 102B to transfer the BoL to the second entity 102B.

FIG. 6 is a flowchart representative of example machine readable instructions and/or example operations 600 that may be executed, instantiated, and/or performed by programmable circuitry to receive asset information (e.g., a BoL) from another entity via a gateway and to analyze geo-fence policies related to the asset transfer. To facilitate description, the description of FIG. 6 is described in connection with the asset management server 106B of the second entity 102B receiving the information from the first entity 102A (e.g., by way of the transmission process described in conjunction with FIG. 5). Of course, the process of FIG. 6 may, alternatively, implement the asset management server 106A.

The example machine-readable instructions and/or the example operations 600 of FIG. 6 begin at block 602, at which transfer analyzer circuitry 204 of the asset management server 106B determines if an incoming asset transfer meets geo-fence policies (block 602). For example, the transfer analyzer circuitry 204 evaluates the consequences of the negotiation/rules for transfer of the asset to determine acceptable terms prior to the transfer. If the transfer analyzer circuitry 204 determines that the geo-fence policies cannot be met, the transfer analyzer circuitry 204 rejects the asset (block 610). For example, the asset transfer may be rejected before it begins and/or the asset may be returned to the first entity 102A if the asset has already been physically transported. In some examples, for the asset to return to the originating geo-fence zone (after a SAT transaction has finalized), a new SAT transaction must be started that includes synchronizing the return. Postal services such as USPS, CANADA POST, etc. may use such techniques to manage exchange of goods across international borders.

If the transfer analyzer circuitry 204 determines that the asset transfer meets geo-fence policies (block 602), the transfer analyzer circuitry 204 obtains asset information from the gateway 108B via the gateway interface circuitry 210 (block 604). For example, the asset may be transferred to a warehouse of the second entity 102B at which point information about the received asset may be generated, collected, etc. The attestation analyzer circuitry 206 also obtains attestation information from the carrier (e.g., the carrier 110B) for the asset via the carrier interface circuitry 208 (block 606). The example attestation analyzer 206 determines if the asset information matches the attestation information (block 608). If the asset information does not match the attestation information (or the attestation information is not available for review), the attestation analyzer circuitry 206 rejects the asset (block 610). For example, the attestation analyzer circuitry 206 may refuse to accept the asset, may reject the BoL, and/or may otherwise cause the asset to be transferred back to the first entity.

If the attestation information is validated (block 608), the attestation analyzer circuitry 206 delivers asset information (e.g., the BoL to the carrier (block 612). The transfer analyzer circuitry 204 then accepts the transfer of the asset to the asset management server 206B (block 614).

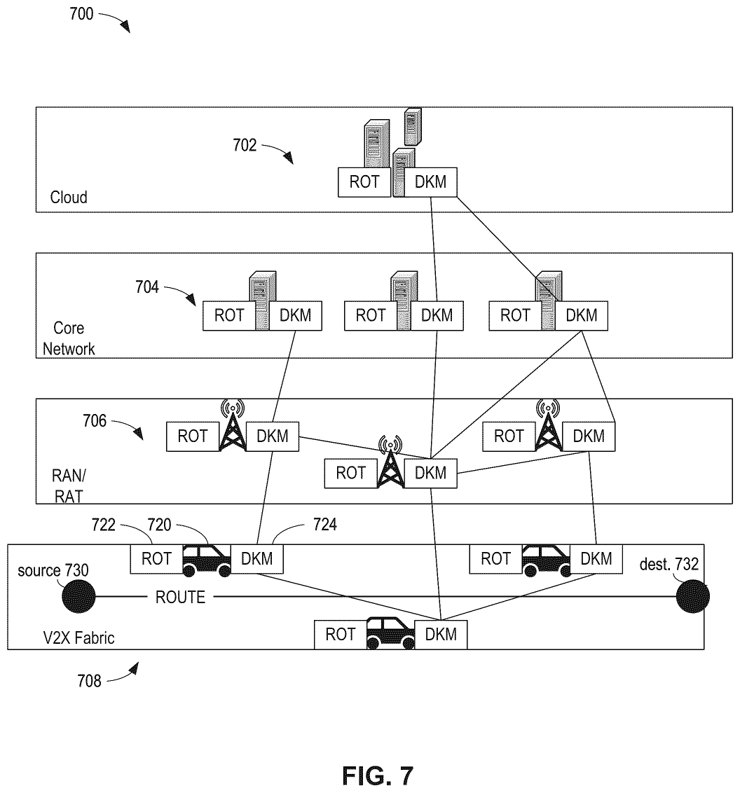

While FIGS. 1-7 are described in conjunction with transfer of information in a supply chain, such trusted information transfer may be utilized in other technology areas. For example, FIGS. 7-9 describe methods and apparatus to manage trusted information in vehicle communication systems. Example methods and apparatus include a vehicle to anything (V2X) node manager that manager (VNM) a V2X node route through a V2X infrastructure (e.g., a route from a source to a destination). Example methods and apparats include a decentralized key manager (DKM) that may be included in the VNM or a standalone element that manages trust and security for decentralized and distributed key architecture among a fabric of V2X nodes. A route of trust that has a triad relationship between a V2X node containing a VNM that utilizes keys derived from the triad relationship to perform the functions of the DKM and/or the VNM in the form of an event log that may be witnessed and watched by peer V2X nodes. In some examples, because the event log is witnessed and watched by peers, it can be trusted and the logged information from one vehicle or other traffic element may be trusted by a vehicle for use in, for example, navigation.

FIG. 7 is a block diagram of an example environment 700 representative of an environment in which a vehicle may transit from a source to a destination in communication with various peers which form a communication mesh with various networked systems. The example environment 100 includes example cloud resources 702, example core network resources 704, example radio access network/radio access technology resources 706, and example V2X fabric resources 708.

In a V2V scenario, a vehicle interacts with several peers in a V2X Fabric that occur along route of the vehicle (e.g., from a source 730 to a destination 732). The example RAN/RAT resources 706 provide context for V2X peers (e.g., a first peer 720) that interact along the route by supplying attestation results obtained from vehicles at other locations along the route (e.g., the beginning and middle of the route). The core network resources 704 and the cloud resources 702 provide support for the V2X fabric.

As illustrated in the example of FIG. 7, the example peer vehicle includes a Root of Trust (RoT) 722 and a decentralized key manager (DKM) 724. According to the illustrated example, the DKM 724 contains the example RoT 722, which is a hardware RoT so that V2X nodes can reliably determine the trust in peer V2X nodes (e.g., when a previously unknown autonomous V2X node appears in a localized Edge network). For example, if a node trusts the implementation of the RoT 722, information reported by the vehicle 720 including the DKM 724 that includes the RoT 722 can be trusted (e.g., determined to not be compromised). For example, compromise of a peer device often cannot be detected unless a private key is disclosed publicly. Methods and apparatus disclosed herein facilitate decentralized evaluation of key usage and key event logs. A compromise in another node may be detected where disparity of the key usage and/or key event logs across multiple peers exists. As illustrated in FIG. 7, many devices at many different levels within the environment 100 may implement a DKM, such as DKM 724, and a RoT, such as RoT 722 to facilitate many different decentralized watchers and witnesses for efficient analysis of trust.

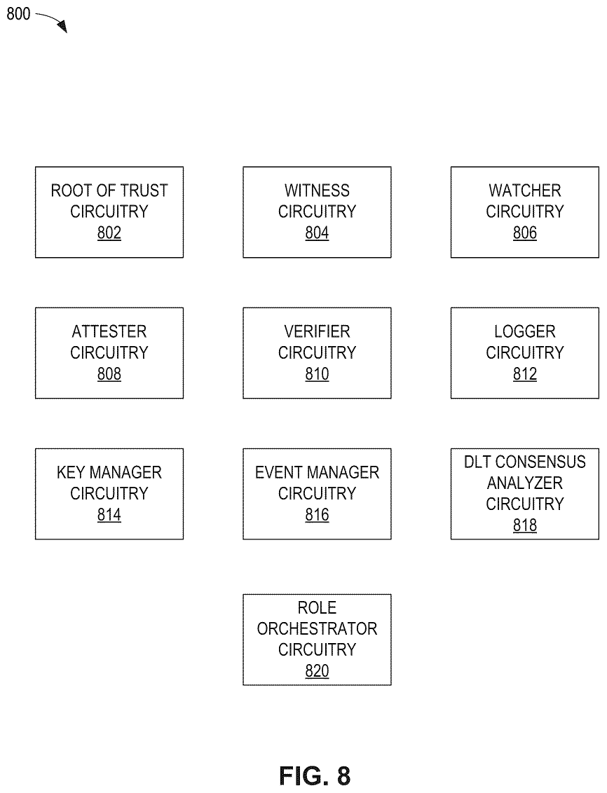

To manage the decentralized interaction among devices in the environment 100, one or more of the resources in the network includes an example V2X node manager (VNM) 800. An example implementation of the VNM 800 is illustrated in FIG. 8. As vehicles along the route from source 730 to destination 732 arrive/exit the V2X Fabric 708, a minimum number of participants in a decentralized trust evaluation is maintained by the VNM 800 to ensure a consensus threshold. A threshold of nodes to establish a consensus is a configuration parameter that may be set dynamically based on the route and projections of how many peer vehicles are likely to exist along the route or can be fixed. Nodes included in the consensus may also include stationary Infrastructure nodes to achieve the minimum number of nodes. A trusted stationary infrastructure node may also provide specific input to set up or update a DLT consensus clique size parameter. Stationary infrastructure nodes may be utilized during levels of high traffic (e.g., a road crash/emergency causing sudden congestion).

The example VNM 800 of FIG. 8 includes an example root of trust circuitry 802, an example witness circuitry 804, an example watcher circuitry 806, an example attester circuitry 808, an example verifier circuitry 810, an example logger circuitry 812, an example key manager circuitry 814, an example event manager circuitry 816, an example DLT consensus analyzer circuitry 818, and an example role orchestrator circuitry 820. While a variety of circuitry are illustrated in the example VNM 800 of FIG. 8, not every node in the environment 700 may include all of the circuitry. For example, a node that is strictly a witness may include only the root of trust circuitry 802, the witness circuitry 804, the example logger circuitry, the example key manager circuitry 814, and the example event manager circuitry 816. In other examples, each VNM 800 may includes all of the circuitry but the role orchestrator circuitry 820 may control operation of which circuitry are operated to support a specific role (e.g., witness, watcher, etc.) of the node at which the particular VNM 800 is implemented.

According to the consensus based approach, example role orchestrator circuitry 820 determines how many nodes are needed that perform specific roles (e.g., by analyzing a setting for a number of nodes to establish a consensus). For example, role orchestrator circuitry 820 may determine that there should be equivalent numbers of witness nodes and watcher nodes. While there may only be a single Role Orchestrator role active in the V2X fabric, for resiliency reasons there may be one or more backup Role Orchestrator nodes identified. According to the illustrated example, a given role orchestrator circuitry 820 does not have the ability to change a consensus algorithm that specifies how many nodes of a particular type of role are needed. However, the role orchestrator 820 may direct certain nodes to take on a role orchestrator backup or to switch roles (e.g., to switch from being a witness role to a watcher role or from being a logger role to a verifier role, etc.). The dynamics of a V2X mesh such as the environment 700 are such that nodes are entering and leaving constantly. Accordingly, role assignments are changing constantly. Nevertheless, the role orchestrator performs a consensus algorithm to ensure that the role assignments fall within expected parameters. Such balancing facilitates operating a mesh without a central controller.

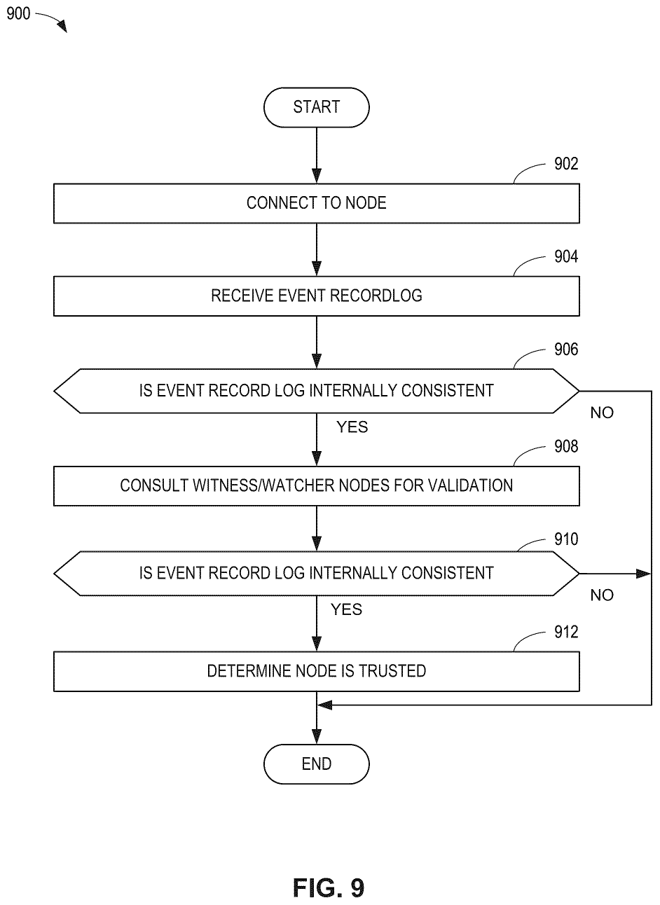

FIG. 9 is a flowchart representative of example machine readable instructions and/or example operations 900 that may be executed, instantiated, and/or performed by programmable circuitry to evaluate trust in a peer node in a distributed mesh environment such as the environment 700 of FIG. 7.

The example machine-readable instructions and/or the example operations 900 of FIG. 9 begin at block 902, at which the DKM 800 (e.g., the DKM 800 of a vehicle transiting from the source 730 to the destination 732 in the environment 700 of FIG. 7. The example verifier circuitry 810 receives an example event record log as part of the connection (block 904). For example, the event record log may be a key event receipt infrastructure (KERI) event record log (KERL). The example verifier circuitry 810 then determines if the log is internally consistent (block 906). For example, the verifier circuitry 810 may determine if the log includes inconsistencies. If the verifier circuitry 810 determines that the event record log is internally inconsistent, the process of FIG. 9 ends and the peer is not trusted.

If the verifier circuitry 810 determines that the log is internally consistent (block 906), the verifier circuitry 810 consults peer nodes that are assigned the witness role and the watcher nodes (block 908). For example, the community of witness nodes can detect duplicitous behavior among witness nodes by soliciting help from watcher nodes that evaluate what was witnessed by witness nodes as contained in KERLs. If the verifier circuitry 810 determines that the record log cannot be validated by the witness/watcher nodes, the process of FIG. 9 ends and the peer is not trusted. If the verifier circuitry 810 determines that the record log can be trusted, the verifier circuitry 810 determines that the node is trusted (block 912).

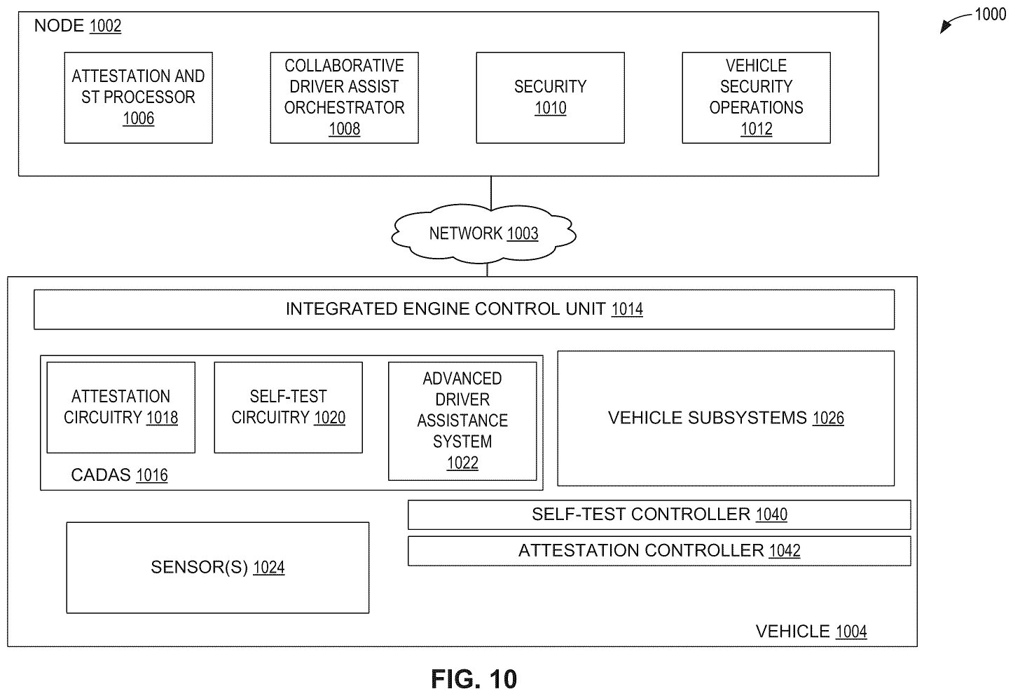

FIG. 10 is a block diagram of an example environment 1000 in which a vehicle 1004 that includes automated driving capabilities communicates with an automated driving controller node 1002 via an example network 1003.

Autonomous vehicles with Advanced Driver Assist System (ADAS) systems support various automation levels (e.g., Society of Automotive Engineers (SAE) Driving Automation (SAE-DA) levels). Vehicles with various levels may be present in Edge networks at the same time. For example, the SAE-DA includes 6 levels of autonomy in automobiles: 0—No Automation (Human Operated)—Level 1—Driver Controls Everything (No Automated Driving Systems)—Level 2—Partial Automation (Driver Assistance)—Level 3—Limited Self-Driving Capabilities—Level 4—Full Self-Driving Capabilities (Driver Not Required) and Level 5—steering wheel optional. SAE-DA also specifies V2X behavior that includes strategies for collision avoidance (other SAE-DA capable vehicles) and vulnerable roadside user (VRU) avoidance (non-SAE-DA capable vehicles). SAE-DA controls differ depending on the SAE-DA level automation of the vehicle.

An SAE-DA level can be represented electronically using a data definition language such as JSON, CDDL, XML etc. The SAE-DA evaluation lab may issue an SAE-DA rating for a class (vendor, model) of vehicle then publish the rating to all Edge traffic controllers. The vehicle may also attest the SAE-DA level as part of attestation evidence that is also delivered to Edge traffic controllers. Edge traffic controllers may verify the SAE-DA level is associated with the vehicle being controlled then select an appropriate control strategy based on that knowledge. For example, the avoidance strategy may have micro adjustment control signals that work within the capabilities of the peer V2X node to avoid collisions. The control signals may find the vehicle paths based on a CADAS context.

A vehicle may rated for a particular automation level based on its safety and analysis features. However, if one or more of those features are not functioning properly, the vehicle may not meet the requirements for the automation level. Thus, the vehicle may report to other vehicles that it meets an automation level and those other vehicles may expect the vehicle to operate accordingly. Methods and apparatus disclosed herein facilitate attestation of the features (e.g., sensors) of a vehicle such that an automation level can be reported and can be trusted by other vehicles in a network.

Attestation is a trusted computing function that reports node configuration and provenance. Misconfigured nodes can be detected and flagged for follow-up investigation. However, in V2X Edge networks, misconfigured nodes cannot be flagged for follow-up investigation, or ignored or quarantined, which is the typical response for attestation in traditional information systems. V2X nodes have greater potential to cause harm and mortality, hence utilize greater integration of safety control with trust assurance. Collaborative avoidance control means the safest vehicles will be those that can assess the safety capabilities (e.g., ADAS) of peer vehicles in their proximity.

Turning to FIG. 10, the example node 1002 is a V2X peer (e.g., an automobile traveling near the vehicle 1004. Alternatively, the node 1004 may be an edge node, a cloud node, or any other type of node that may communicate with the vehicle 1004. The example node 1004 includes an example attestation and self-test processor circuitry 1006, an example collaborative driver assist orchestrator circuitry 1008, an example security circuitry 1010, and an example vehicle security operations circuitry 1012.

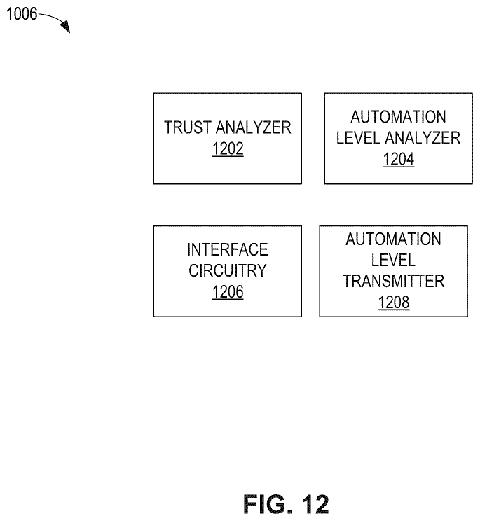

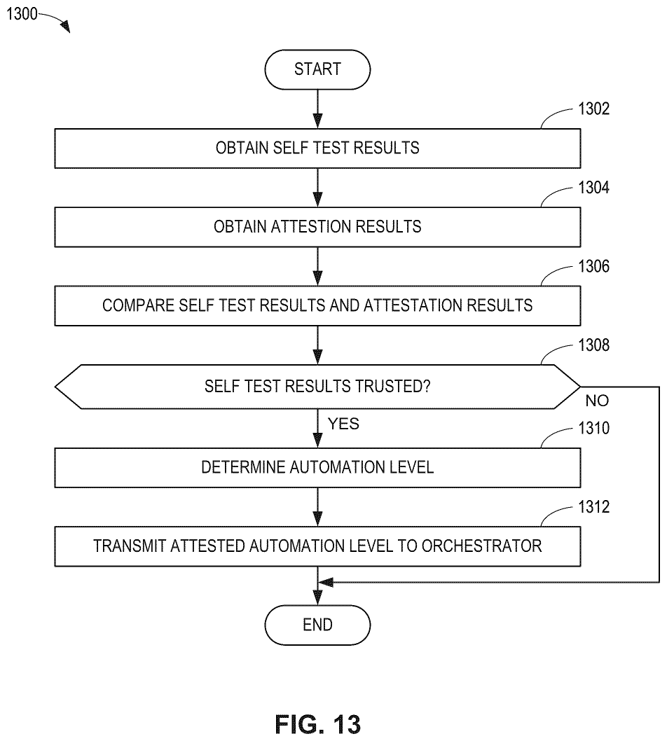

The example attestation and self-test processor circuitry 1006 obtains evidence, self-test results, and attestation information reported by another node (e.g., the vehicle 1004) and analyzes the information to determine if the information is trustworthy as well as using the information to determine an automation level associated with the node that reported the information. An example implementation of the attestation and self-test processor circuitry 1006 is described in conjunction with FIG. 12. In some examples, the attestation and self-test processor circuitry 1006 is instantiated by programmable circuitry executing attestation and self-test processor circuitry instructions and/or configured to perform operations such as those represented by the flowchart(s) of FIG. 13.

In some examples, the node 1002 includes means for attestation and self-test analysis. For example, the means for attestation and self-test analysis may be implemented by attestation and self-test processor circuitry 1006. In some examples, the attestation and self-test processor circuitry 1006 may be instantiated by programmable circuitry such as the example programmable circuitry 1512 of FIG. 15. For instance, the attestation and self-test processor circuitry 1006 may be instantiated by the example microprocessor 1500 of FIG. 15 executing machine executable instructions such as those implemented by at least blocks 1302 to 1312 of FIG. 13. In some examples, the attestation and self-test processor circuitry 1006 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the attestation and self-test processor circuitry 1006 may be instantiated by any other combination of hardware, software, and/or firmware. For example, the attestation and self-test processor circuitry 1006 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example collaborative driver assist orchestrator circuitry 1008 gather's information received from multiple vehicles near the vehicle 1004 to provide collaborative guidance information based on the attested information.

The example security circuitry 1010 is an example secure storage (e.g., an enclave such as an INTEL SGX enclave). The example security circuitry 1010 stores attestation results from the attestation and self-test processor circuitry 1006.

The example vehicle security operations circuitry 1012 is processing circuitry to monitor and manage security of a V2X system. For example, the vehicle security operations circuitry 1012 may monitor communications to look for malicious communications and/or nodes, may monitor for device and/or network outages, etc.

The example network 1003 is a wireless cellular network to communicatively couple the node 1002 and the vehicle 1004. Alternatively, the network 1003 may be any type and/or combination of types of networks such as wireless networks, wired networks, wide area networks, local area networks, point to point networks, peer to peer networks, etc.

The example vehicle 1004 includes an example integrated engine control unit (ECU) circuitry 1014, an example collaborative ADAS (CADAS) 1016, example sensors 1024, example vehicle subsystems 1026, example self-test controller circuitry 1040, and example attestation controller circuitry 1042.

The example integrated ECU circuitry 1014 and vehicle subsystems 1026 are standard automotive control system components that are not described in further detail herein. The example vehicle subsystems 1026 may include one or more of diagnosis circuitry, inter-vehicle communications (IVC) circuitry, car to anything (C2X) circuitry, in-vehicle infotainment (IVI) circuitry, parking circuitry, mobile processing unit (MPU) circuitry, body control circuitry, etc.

The example CADAS circuitry 1016 includes example attestation circuitry 1018, example self-test controller circuitry 1020, an example advanced driver assistance system circuitry 1022.

The example attestation circuitry 1018 is communicatively coupled to the example sensors 1024 and the example attestation controllers 1042 to receive attestation evidence and report the attestation evidence to the attestation and self-test processor circuitry 1006 of the node 1002.

The example self-test circuitry 1020 is communicatively coupled to the example self-test controller circuitry 1040 and the example sensors 1024 to collect self-test information and report the self-test information to the attestation circuitry 1018 for comparison with the attestation evidence.

The advanced driver assistance system (ADAS) circuitry 1022 controls multiple driver assistance functions such as adaptive speed control, automated braking, collision avoidance, collision alerts, object recognition (e.g., traffic sign recognition), parking assistance, blind spot detection and alerting, etc. According to the illustrated example, the ADAS 1022 receives information from the CADAS 1008 of the node 1004 to affect operations. For example, the CADAS 1008 may alert the ADAS 1022 about information received from other vehicles and/or may direct operation of the ADAS 1022 based on information collected by the CADAS 1006.

The example self-test controller circuitry 1040 analyzes behaviors and states of the example sensors 1024 and other vehicle components to determine self-test results. For example, the self-test controller circuitry 1040 may have a procedure for testing the operation of a camera to verify that the camera is functional, not blocked or obscured, properly calibrated within a specification, etc. For example, a self-test may collect data regarding entry/exit states and may monitor operational states to deduce unsafe patterns. Self-test information may report an automation level (e.g., a SAE-DA level) (in addition to other test results). The self-test controller circuitry 1040 transmits self-test information to the self-test circuitry 1020. According to the illustrated example, the self-test controller circuitry 1040 is closely integrated with the sensors 1024 and other components of the vehicle 1004 such that the self-test controller circuitry 1040 is provided with details of the component's safety behavior and states. An example self-test design may include exposing safety status registers to a trusted monitoring environment or designating a “test” mode that allows the device to be introspected to better assess operations. If test-mode operation results in operations that are less-safe, the system will ensure that ‘test mode’ cannot be entered while the vehicle is operational (for example, control to actuators might be decoupled during test mode). While the illustrated example illustrates a single self-test controller circuitry 1040 there may be multiple controllers (e.g., a controller for each component type).

The example attestation controller circuitry 1042 analyzes behaviors and states of the example sensors 1024 and other vehicle components to determine attestation information for the components. For example, the attestation controller circuitry 1042 may be closely integrated with the components so that the attestation controller circuitry 1042 may collect information from a component without the component misrepresenting the information. The example attestation controller circuitry 1042 also collects attestation measurements from the self-test controller circuitry 1040 as part of the overall evidence collection goal. The attestation controller circuitry 1042 transmits self-test information to the attestation circuitry 1018. While the illustrated example illustrates a single attestation controller circuitry 1042 there may be multiple controllers (e.g., a controller for each component type).

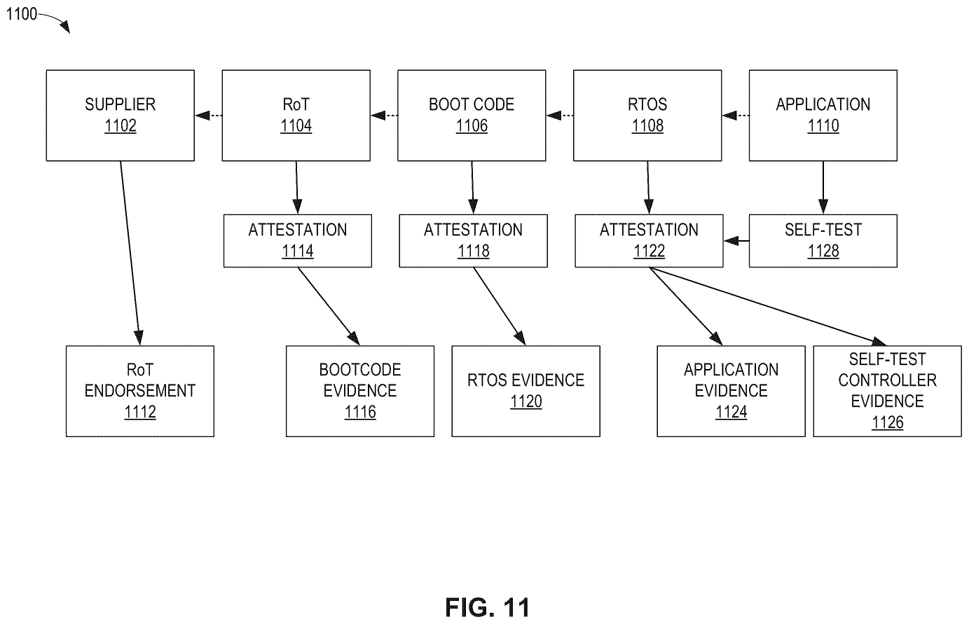

FIG. 11 illustrates an implementation of an example attestable chain of trust 1100 of one of the example sensors 1024 of FIG. 10. The example chain of trust 1100 includes self-test and attestation capabilities to support the CADAS 1008. According to the illustrated example, the chain of trust includes a supplier 1102 that attests an example root of trust (RoT) 1104 via an example RoT endorsement 1112. The example RoT 1104 attests 1114 an example boot code 1106 of the sensor 1124 to generate bootcode evidence 1116. The example boot code 1106 attests 1118 an example operation system (e.g., real time operating system 1108) to generate RTOS evidence 1120. The example RTOS 1108 attests 1122 an example application 1110 (e.g., an application to operate a sensor such as a camera application, a LIDAR application, a RADAR application, etc.) to generate application evidence 1124. The example RTOS 1108 also attests 1122 a self-test controller 1128 to generate self-test controller evidence 1126. According to the example chain of trust 1100, by following a chain of trust from the supplier 1102 to an application 1110 and the self-test controller 1128 all components along the chain can be trusted by any entity that trusts the supplier 1102.

FIG. 12 is a block diagram of an example implementation of the attestation and self-test processor 1006 of FIG. 10. The example attestation and self-test processor 1006 of FIG. 12 includes an example trust analyzer circuitry 1202, an example automation level analyzer 1204, an example interface circuitry 1206, and an example automation level transmitter 1208.

The example trust analyzer circuitry 1202 receives self-test results and attestation results from the vehicle 1004 (e.g., from the attention circuitry 1018) and compares the self-test results and the attestation results (e.g., evidence) to determine if the self-test results can be trusted to accurately reflect the operational state of the tested component. For example, the trust analyzer circuitry 1202 may confirm that the components have been attested and then compare the self-test results against test results provided by a manufacturer or other source of reference values. If the trust analyzer circuitry 1202 observes a disparity between reported values and a reference value (e.g., a difference that meets and/or exceeds a threshold) the trust analyzer circuitry 1202 may indicate that the component cannot be trusted. In some examples, the trust analyzer circuitry 1202 is instantiated by programmable circuitry executing trust analyzer instructions and/or configured to perform operations such as those represented by the flowchart(s) of FIG. 13.

In some examples, the trust analyzer circuitry 1202 includes means for analyzing trust. For example, the means for analyzing trust may be implemented by trust analyzer circuitry 1202. In some examples, the trust analyzer circuitry 1202 may be instantiated by programmable circuitry such as the example programmable circuitry 1512 of FIG. 15. For instance, the trust analyzer circuitry 1202 may be instantiated by the example microprocessor 1600 of FIG. 16 executing machine executable instructions such as those implemented by at least blocks 1302-1306 of FIG. 13. In some examples, the trust analyzer circuitry 1202 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the trust analyzer circuitry 1202 may be instantiated by any other combination of hardware, software, and/or firmware. For example, the trust analyzer circuitry 1202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example automation level analyzer 1204 analyzes the results of the trust analyzer 1202 to determine an automation level (e.g., an SAE DA level) for the vehicle 1004. For example, the automation level analyzer 1204 determines which sensors may be reported as outside of expected operation and may account for that information when determining an automation level. In a particular example, if a camera that observes a roadway for collision avoidance is detected as functional an automation level for the vehicle may be downgraded to a level that does not require such a sensor. In some examples, the automation level analyzer 1204 is instantiated by programmable circuitry executing trust analyzer instructions and/or configured to perform operations such as those represented by the flowchart(s) of FIG. 13.

In some examples, the automation level analyzer 1204 includes means for analyzing an automation level. For example, the means for analyzing an automation level may be implemented by trust analyzer circuitry 1202. In some examples, the automation level analyzer 1204 may be instantiated by programmable circuitry such as the example programmable circuitry 1512 of FIG. 15. For instance, the automation level analyzer 1204 may be instantiated by the example microprocessor 1600 of FIG. 16 executing machine executable instructions such as those implemented by at least blocks 1308-1310 of FIG. 13. In some examples, the automation level analyzer 1204 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the automation level analyzer 1204 may be instantiated by any other combination of hardware, software, and/or firmware. For example, the automation level analyzer 1204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example interface circuitry 1206 communicatively couples the automation and self-test processor 1006 with the vehicle 1004. The example interface circuitry 1206 is cellular network interface. Alternatively the interface circuitry 1206 may be any type of communication circuitry such as wired network circuitry, wireless network circuitry, peer to peer network circuitry, etc.

The example automation level transmitter 1208 transmits a determined automation level to the example collaborative driver assist orchestrator circuitry 1008 via the interface circuitry 1206. For example, the automation level transmitter 1208 may transmit a single automation level and/or may transmit detailed information about multiple automation levels for different aspects (e.g., self-driving, collision avoidance, driver monitoring, etc.). In some examples, the automation level transmitter 1208 is instantiated by programmable circuitry executing trust analyzer instructions and/or configured to perform operations such as those represented by the flowchart(s) of FIG. 13.

In some examples, the automation level transmitter 1208 includes means for transmitting. For example, the means for transmitting may be implemented by automation level transmitter 1208. In some examples, the automation level transmitter 1208 may be instantiated by programmable circuitry such as the example programmable circuitry 1512 of FIG. 15. For instance, the automation level transmitter 1208 may be instantiated by the example microprocessor 1600 of FIG. 16 executing machine executable instructions such as those implemented by at least block 1312 of FIG. 13. In some examples, the automation level transmitter 1208 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the automation level transmitter 1208 may be instantiated by any other combination of hardware, software, and/or firmware. For example, the automation level transmitter 1208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 13 is a flowchart representative of example machine readable instructions and/or example operations 1300 that may be executed, instantiated, and/or performed by programmable circuitry to implement the attestation and self-test processor 1006 to determine an automation level supported by one or more sensors based on analysis of self-test and attestation results from the sensor.

The example instructions 1300 begin at block 1302 at which the example trust analyzer 1202 obtains self-test results from a node (e.g., the vehicle 1004) via the interface circuitry 1202 (block 1302). The example trust analyzer 1202 also obtains attestation results via the interface circuitry 1202 (block 1304). The example trust analyzer 1202 then compares the self-test results and the attestation result to determine if the results indicate trusted (block 1306). For example, the trust analyzer 1202 may determine if the trust evidence evidences a chain a trust from a trusted entity (e.g., a supplier)

If trust analyzer 1202 determines that the attestation data indicates that the self-test data cannot be trusted (e.g., an element in the chain of trust was not trusted), the process of FIG. 13 ends and the self-test data is not utilized for evaluating an automation level (block 1308). If the trust analyzer 1202 determines that the self-test data can be trusted, the automation level analyzer 1204 determines an automation level based on the self-test results (block 1310). For example, the automation level analyzer circuitry 1204 may compare the self-test results to reference data to determine if the self-test indicates a properly operating sensor and, if not, the automation level analyzer circuitry 1204 may determine an automation level for a vehicle that doesn't include the particular sensor. The example automation level transmitter 1208 then transmits the automation level to the example collaborative driver assist orchestrator 1008 via the example interface circuitry 1206 (block 1312).

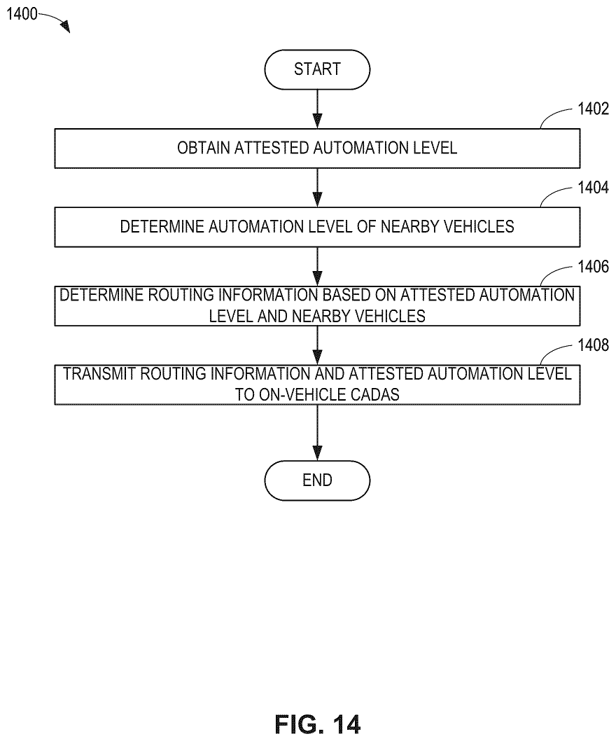

FIG. 14 is a flowchart representative of example machine readable instructions and/or example operations 1400 that may be executed, instantiated, and/or performed by programmable circuitry to utilize an automation level by the collaborative driver assist orchestrator 1008. The example instructions 1400 begin at block 1402 at which the collaborative driver assist orchestrator circuitry 1008 obtains the attested automation level from the example attestation and self-test processor circuitry 1006. The example collaborative driver assist orchestrator circuitry 1008 determines an automation level of vehicles near the vehicle 1004 (block 1404). For example, the collaborative driver assist orchestrator circuitry 1008 may obtain attested automation levels from nearby vehicles and/or other nodes. The collaborative driver assist orchestrator circuitry 1008 determines routing information based on the attested automation level and the nearby vehicles (block 1406). The example collaborative driver assist orchestrator circuitry 1008 transmits the routing information and attested automation level to the on-vehicle CADAS 1016 of the vehicle 1004 to allow the CADAS 1016 to control operation based on a context of the vehicles around it. For example, the collaborative driver assist orchestrator circuitry 1008 may control routing based on automation levels. For example, if two vehicles approaching an intersection are on a collision course but have an attested automation level that indicates that the they will independently control their operation to safely travel through the intersection. On the other hand, if the attested automation level indicates that one of the vehicles actually has a lower automation level (e.g., a level that is reduced from its as-built automation level because a sensor is not operational), the collaborative driver assist orchestrator circuitry 1008 may intervene to direct one or both vehicles to change operation to avoid a collision.

FIG. 15 is a block diagram of an example programmable circuitry platform 1500 structured to execute and/or instantiate the example machine-readable instructions and/or the example operations of FIGS. 3-6, 9, 13, 14 to implement the asset management server 106 of FIG. 2, the V2X node manager 800 of FIG. 8, and/or the attestation and self-test processor 1006 of FIG. 11. The programmable circuitry platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1532, which may be implemented by the machine readable instructions of FIGS. 3-6, 9, 13, 14, may be stored in the mass storage device 1528, in the volatile memory 1514, in the non-volatile memory 1516, and/or on at least one non-transitory computer readable storage medium such as a CD or DVD which may be removable.

FIG. 16 is a block diagram of an example implementation of the programmable circuitry 1512 of FIG. 15. In this example, the programmable circuitry 1512 of FIG. 15 is implemented by a microprocessor 1600. For example, the microprocessor 1600 may be a general-purpose microprocessor (e.g., general-purpose microprocessor circuitry). The microprocessor 1600 executes some or all of the machine-readable instructions of the flowcharts of FIGS. 3-6, 9, 13, 14 to effectively instantiate the circuitry of FIG. 2 as logic circuits to perform operations corresponding to those machine readable instructions. In some such examples, the circuitry of FIG. 2 is instantiated by the hardware circuits of the microprocessor 1600 in combination with the machine-readable instructions. For example, the microprocessor 1600 may be implemented by multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine readable instructions and/or operations represented by the flowcharts of FIGS. 3-6, 9, 13, 14.

The cores 1602 may communicate by a first example bus 1604. In some examples, the first bus 1604 may be implemented by a communication bus to effectuate communication associated with one(s) of the cores 1602. For example, the first bus 1604 may be implemented by at least one of an Inter-Integrated Circuit (I2C) bus, a Serial Peripheral Interface (SPI) bus, a PCI bus, or a PCIe bus. Additionally or alternatively, the first bus 1604 may be implemented by any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2 cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the local memory 1620, and a second example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating-point operations. In yet other examples, the AL circuitry 1616 may include first AL circuitry that performs integer-based operations and second AL circuitry that performs floating-point operations. In some examples, the AL circuitry 1616 may be referred to as an Arithmetic Logic Unit (ALU).

The registers 1618 are semiconductor-based structures to store data and/or instructions such as results of one or more of the operations performed by the AL circuitry 1616 of the corresponding core 1602. For example, the registers 1618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure, such as by being distributed throughout the core 1602 to shorten access time. The second bus 1622 may be implemented by at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages.

The microprocessor 1600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1600, in the same chip package as the microprocessor 1600 and/or in one or more separate packages from the microprocessor 1600.

FIG. 17 is a block diagram of another example implementation of the programmable circuitry 1512 of FIG. 15. In this example, the programmable circuitry 1512 is implemented by FPGA circuitry 1700. For example, the FPGA circuitry 1700 may be implemented by an FPGA. The FPGA circuitry 1700 can be used, for example, to perform operations that could otherwise be performed by the example microprocessor 1600 of FIG. 16 executing corresponding machine readable instructions. However, once configured, the FPGA circuitry 1700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1600 of FIG. 16 described above (which is a general purpose device that may be programmed to execute some or all of the machine readable instructions represented by the flowchart(s) of FIGS. 3-6, 9, 13, 14 but whose interconnections and logic circuitry are fixed once fabricated), the FPGA circuitry 1700 of the example of FIG. 17 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6, 9, 13, 14. In particular, the FPGA circuitry 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6, 9, 13, 14. As such, the FPGA circuitry 1700 may be configured and/or structured to effectively instantiate some or all of the operations/functions corresponding to the machine readable instructions of the flowchart(s) of FIGS. 3-6, 9, 13, 14 as dedicated logic circuits to perform the operations/functions corresponding to those software instructions in a dedicated manner analogous to an ASIC. Therefore, the FPGA circuitry 1700 may perform the operations/functions corresponding to the some or all of the machine readable instructions of FIGS. 3-6, 9, 13, 14 faster than the general-purpose microprocessor can execute the same.

In the example of FIG. 17, the FPGA circuitry 1700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1700 of FIG. 17 may access and/or load the binary file to cause the FPGA circuitry 1700 of FIG. 17 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1700 of FIG. 17 may access and/or load the binary file to cause the FPGA circuitry 1700 of FIG. 17 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

The FPGA circuitry 1700 of FIG. 17, includes example input/output (I/O) circuitry 1702 to obtain and/or output data to/from example configuration circuitry 1704 and/or external hardware 1706. For example, the configuration circuitry 1704 may be implemented by interface circuitry that may obtain a binary file, which may be implemented by a bit stream, data, and/or machine-readable instructions, to configure the FPGA circuitry 1700, or portion(s) thereof. In some such examples, the configuration circuitry 1704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1706 may be implemented by external hardware circuitry. For example, the external hardware 1706 may be implemented by the microprocessor 1600 of FIG. 16.

The FPGA circuitry 1700 also includes an array of example logic gate circuitry 1708, a plurality of example configurable interconnections 1710, and example storage circuitry 1712. The logic gate circuitry 1708 and the configurable interconnections 1710 are configurable to instantiate one or more operations/functions that may correspond to at least some of the machine readable instructions of FIGS. 3-6, 9, 13, 14 and/or other desired operations. The logic gate circuitry 1708 shown in FIG. 17 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations/functions. The logic gate circuitry 1708 may include other electrical structures such as look-up tables (LUTs), registers (e.g., flip-flops or latches), multiplexers, etc.

The configurable interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example dedicated operations circuitry 1714. In this example, the dedicated operations circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the programmable circuitry 1512 of FIG. 15, many other approaches are contemplated. For example, FPGA circuitry may include an on-board CPU, such as one or more of the example CPU 1720 of FIG. 16. Therefore, the programmable circuitry 1512 of FIG. 15 may additionally be implemented by combining at least the example microprocessor 1600 of FIG. 16 and the example FPGA circuitry 1700 of FIG. 17. In some such hybrid examples, one or more cores 1602 of FIG. 16 may execute a first portion of the machine readable instructions represented by the flowchart(s) of FIGS. 3-6, 9, 13, 14 to perform first operation(s)/function(s), the FPGA circuitry 1700 of FIG. 17 may be configured and/or structured to perform second operation(s)/function(s) corresponding to a second portion of the machine readable instructions represented by the flowcharts of FIG. 3-6, 9, 13, 14, and/or an ASIC may be configured and/or structured to perform third operation(s)/function(s) corresponding to a third portion of the machine readable instructions represented by the flowcharts of FIGS. 3-6, 9, 13, 14.

It should be understood that some or all of the circuitry of FIG. 2 may, thus, be instantiated at the same or different times. For example, same and/or different portion(s) of the microprocessor 1600 of FIG. 16 may be programmed to execute portion(s) of machine-readable instructions at the same and/or different times. In some examples, same and/or different portion(s) of the FPGA circuitry 1700 of FIG. 17 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1600 of FIG. 16 may execute machine readable instructions in one or more threads executing concurrently and/or in series. In some examples, the FPGA circuitry 1700 of FIG. 17 may be configured and/or structured to carry out operations/functions concurrently and/or in series. Moreover, in some examples, some or all of the circuitry of FIG. 2 may be implemented within one or more virtual machines and/or containers executing on the microprocessor 1600 of FIG. 16.

In some examples, the programmable circuitry 1512 of FIG. 15 may be in one or more packages. For example, the microprocessor 1600 of FIG. 16 and/or the FPGA circuitry 1700 of FIG. 17 may be in one or more packages. In some examples, an XPU may be implemented by the programmable circuitry 1512 of FIG. 15, which may be in one or more packages. For example, the XPU may include a CPU (e.g., the microprocessor 1600 of FIG. 16, the CPU 1720 of FIG. 17, etc.) in one package, a DSP (e.g., the DSP 1722 of FIG. 17) in another package, a GPU in yet another package, and an FPGA (e.g., the FPGA circuitry 1700 of FIG. 17) in still yet another package.

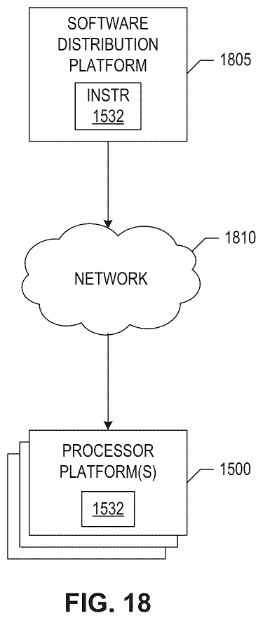

A block diagram illustrating an example software distribution platform 1805 to distribute software such as the example machine readable instructions 1532 of FIG. 15 to other hardware devices (e.g., hardware devices owned and/or operated by third parties from the owner and/or operator of the software distribution platform) is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform 1805. For example, the entity that owns and/or operates the software distribution platform 1805 may be a developer, a seller, and/or a licensor of software such as the example machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532, which may correspond to the example machine readable instructions of FIGS. 3-6, 9, 13, 14, as described above. The one or more servers of the example software distribution platform 1805 are in communication with an example network 1810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. For example, the software, which may correspond to the example machine readable instructions of FIG. 3-6, 9, 13, 14, may be downloaded to the example programmable circuitry platform 1500, which is to execute the machine readable instructions 1532 to implement the asset management server 106 of FIG. 2, the V2X node manager 800 of FIG. 8, and/or the attestation and self-test processor 1006 of FIG. 11. In some examples, one or more servers of the software distribution platform 1805 periodically offer, transmit, and/or force updates to the software (e.g., the example machine readable instructions 1532 of FIG. 15) to ensure improvements, patches, updates, etc., are distributed and applied to the software at the end user devices. Although referred to as software above, the distributed “software” could alternatively be firmware.

Example methods, apparatus, systems, and articles of manufacture for secured information transfer are disclosed herein. Further examples and combinations thereof include the following:

Example 1 includes an apparatus comprising network interface circuitry, instructions, programmable circuitry to execute the instructions to determine characteristics of an asset associated with a first entity that utilizes a first type of decentralized security, assign the asset to a carrier for transport to a second entity that utilizes a second type of decentralized security, obtain attested information for the asset from the carrier, and transmit the attested information to the second entity via a first transfer gateway, the first gateway to transmit the attested information for the asset to a second gateway of the second entity.

Example 2 includes the apparatus of example 1, wherein the programmable circuitry is further to determine if the transport of the asset will meet a geographic policy restriction, wherein the programmable circuitry is to assign the asset to the carrier if the transport will meet the geographic policy.

Example 3 includes the apparatus of example 2, wherein the programmable circuitry is further to cause the first gateway to determine the geographic policy via communication with the second gateway.

Example 4 includes the apparatus of example 1, wherein the first gateway utilizes a secure asset transfer protocol.

Example 5 includes the apparatus of example 1, wherein the programmable circuitry is further to cryptographically protect the attested information prior to transmission to the second entity by the first gateway.

Example 6 includes the apparatus of example 1, wherein asset information is transmitted after a financial transaction associated with a value of the asset.

Example 7 includes the apparatus of example 6, wherein the financial transaction is a decentralized digital currency transaction.

Example 8 includes the apparatus of example 1, wherein the first type of decentralized security is at least one of blockchain, distributed ledger technology, or root of trust.

Example 9 includes the apparatus of example 1, wherein the first entity is a first supply chain supplier network and the second entity is a second supply chain supplier network.

Example 10 includes the apparatus of example 1, wherein the carrier is to transmit the asset to the second entity.

Example 11 includes the apparatus of example 1, wherein the asset is an electronic asset.

Example 12 includes the apparatus of example 1, wherein the attested information is a bill of lading.

Example 13 includes the apparatus of example 1, wherein the first gateway prevents state changes to the asset when the asset is in a process of transfer to the second entity.

Example 14 includes a non-transitory computer readable medium comprising instructions that, when executed, cause a machine to at least determine characteristics of an asset associated with a first entity that utilizes a first type of decentralized security, assign the asset to a carrier for transport to a second entity that utilizes a second type of decentralized security, obtain attested information for the asset from the carrier, and transmit the attested information to the second entity via a first gateway, the first gateway to transmit the attested information for the asset to a second gateway of the second entity.

Example 15 includes the non-transitory computer readable medium of example 14, wherein the instructions, when executed, cause the machine to determine if the transport of the asset will meet a geographic policy restriction, wherein instructions, when executed, cause the machine to assign the asset to the carrier if the transport will meet the geographic policy.

Example 16 includes the non-transitory computer readable medium of example 15, wherein the instructions, when executed, cause the machine to cause the first gateway to determine the geographic policy via communication with the second gateway.

Example 17 includes the non-transitory computer readable medium of example 14, wherein the first type of decentralized security is at least one of blockchain, distributed ledger technology, or root of trust.

Example 18 includes the non-transitory computer readable medium of example 14, wherein the first entity is a first supply chain supplier network and the second entity is a second supply chain supplier network.

Example 19 includes the non-transitory computer readable medium of example 14, wherein the carrier is to transmit the asset to the second entity.

Example 20 includes the non-transitory computer readable medium of example 14, wherein the asset is an electronic asset.

Example 21 includes the non-transitory computer readable medium of example 14, wherein the attested information is a bill of lading.

Example 22 includes the non-transitory computer readable medium of example 14, wherein the first gateway prevents state changes to the asset when the asset is in a process of transfer to the second entity.

Example 23 includes a method comprising determining characteristics of an asset associated with a first entity that utilizes a first type of decentralized security, assigning the asset to a carrier for transport to a second entity that utilizes a second type of decentralized security, obtaining attested information for the asset from the carrier, and transmitting the attested information to the second entity via a first gateway, the first gateway to transmit the attested information for the asset to a second gateway of the second entity.

Example 24 includes the method of example 23, further comprising determining if the transport of the asset will meet a geographic policy restriction, wherein the assigning the asset to the carrier is performed if the transport will meet the geographic policy.

Example 25 includes the method of example 24, further comprising causing the first gateway to determine the geographic policy via communication with the second gateway.

Example 26 includes the method of example 23, wherein the first type of decentralized security is at least one of blockchain, distributed ledger technology, or root of trust.

Example 27 includes the method of example 23, wherein the first entity is a first supply chain supplier network and the second entity is a second supply chain supplier network.

Example 28 includes the method of example 23, wherein the carrier is to transmit the asset to the second entity.

Example 29 includes the method of example 23, wherein the asset is an electronic asset.

Example 30 includes the method of example 23, wherein the attested information is a bill of lading.

Example 31 includes the method of example 23, wherein the first gateway prevents state changes to the asset when the asset is in a process of transfer to the second entity.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
network interface circuitry;
instructions;
programmable circuitry to execute the instructions to:
determine characteristics of an asset associated with a first entity that utilizes a first type of decentralized security;
assign the asset to a carrier for transport to a second entity that utilizes a second type of decentralized security;
obtain attested information for the asset from the carrier; and
transmit the attested information to the second entity via a first transfer gateway, the first gateway to transmit the attested information for the asset to a second gateway of the second entity.

2. The apparatus of claim 1, wherein the programmable circuitry is further to determine if the transport of the asset will meet a geographic policy restriction, wherein the programmable circuitry is to assign the asset to the carrier if the transport will meet the geographic policy.

3. The apparatus of claim 2, wherein the programmable circuitry is further to cause the first gateway to determine the geographic policy via communication with the second gateway.

4. The apparatus of claim 1, wherein the first gateway utilizes a secure asset transfer protocol.

5. The apparatus of claim 1, wherein the programmable circuitry is further to cryptographically protect the attested information prior to transmission to the second entity by the first gateway.

6. The apparatus of claim 1, wherein asset information is transmitted after a financial transaction associated with a value of the asset.

7. The apparatus of claim 6, wherein the financial transaction is a decentralized digital currency transaction.

8. The apparatus of claim 1, wherein the first type of decentralized security is at least one of blockchain, distributed ledger technology, or root of trust.

9. The apparatus of claim 1, wherein the first entity is a first supply chain supplier network and the second entity is a second supply chain supplier network.

10. The apparatus of claim 1, wherein the carrier is to transmit the asset to the second entity.

11. The apparatus of claim 1, wherein the asset is an electronic asset.

12. The apparatus of claim 1, wherein the attested information is a bill of lading.

13. The apparatus of claim 1, wherein the first gateway prevents state changes to the asset when the asset is in a process of transfer to the second entity.

14. A non-transitory computer readable medium comprising instructions that, when executed, cause a machine to at least:
determine characteristics of an asset associated with a first entity that utilizes a first type of decentralized security;
assign the asset to a carrier for transport to a second entity that utilizes a second type of decentralized security;
obtain attested information for the asset from the carrier; and
transmit the attested information to the second entity via a first gateway, the first gateway to transmit the attested information for the asset to a second gateway of the second entity.

15. The non-transitory computer readable medium of claim 14, wherein the instructions, when executed, cause the machine to determine if the transport of the asset will meet a geographic policy restriction, wherein instructions, when executed, cause the machine to assign the asset to the carrier if the transport will meet the geographic policy.

16. The non-transitory computer readable medium of claim 15, wherein the instructions, when executed, cause the machine to cause the first gateway to determine the geographic policy via communication with the second gateway.

17. The non-transitory computer readable medium of claim 14, wherein the first type of decentralized security is at least one of blockchain, distributed ledger technology, or root of trust.

18. The non-transitory computer readable medium of claim 14, wherein the first entity is a first supply chain supplier network and the second entity is a second supply chain supplier network.

19-22. (canceled)

23. A method comprising:
determining characteristics of an asset associated with a first entity that utilizes a first type of decentralized security;
assigning the asset to a carrier for transport to a second entity that utilizes a second type of decentralized security;
obtaining attested information for the asset from the carrier; and
transmitting the attested information to the second entity via a first gateway, the first gateway to transmit the attested information for the asset to a second gateway of the second entity.

24. The method of claim 23, further comprising determining if the transport of the asset will meet a geographic policy restriction, wherein the assigning the asset to the carrier is performed if the transport will meet the geographic policy.

25-31. (canceled)
